(19) United States
(12) Patent Application Publication
(10) Pub. No.: US 2004/0030215 A1
(43) Pub. Date: Feb. 12, 2004

(54) Non-evasive method of breaching layers of confinement in packages

(76) Inventors: Terry J. Wickland, Evergreen, CO (US); Loewen Eric, Idaho Falls, CO (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/393,350

(22) Filed: Mar. 21, 2003

Related U.S. Application Data
(60) Provisional application No. 60/365,773, filed on Mar. 21, 2002.

(51) Int. Cl. G21F 5/00

(52) U.S. Cl. 588/1; 204/157.15

(57) ABSTRACT

In order to vent packages of transuranic waste, such as plutonium 238, the waste is contained in at least one, preferably several plastic bags that form liners in a steel drum 60. The package is irradiated with gamma radiation which passes through the drum and accelerates cross-linking and embrittlement of the bags, rupturing the bags and releasing explosive gas, such as hydrogen or volatile organic compounds, from the bags into the drums. Explosive gas is then vented from the drums, providing packages containing transuranic waste which are transportable under Department of Transportation regulations.

### FIELD OF THE INVENTION

The present invention relates to non-evasive methods of breaching layers of confinement in packages. More particularly, the present invention relates to such a method using at least one beam of high energy gamma radiation to breach bags within a drum containing, but not limited to, waste materials such as but not limited to, radio-active waste materials.

### BACKGROUND OF THE INVENTION

Nuclear waste is stored in multiple layers of confinement, typically 5 to 12 mil polyethylene and/or PVC bags, contained in 30 and/or 55-gallon steel drums. Radiolytic decomposition of the waste contents generates hydrogen and other explosive gases. Each layer of confinement or bag, within the package reduces gas permeability and leakage and therefore the risk of explosive gas concentrations exists. Certain waste streams, for example high and low activity plutonium 238 generates a great deal of hydrogen gas.

Federally established Department of Transportation regulations limit the amount of gas generation that may occur in a single drum during transportation. Drums that contain as little as 10 grams of PU-238 may not be transported until they are repackaged into as many as 10 additional drums. There are about 10,000 drums of PU-238 at DOE facilities that may not be transported for disposal at the WIPP for this reason. The cost of repackaging one drum into ten may be $10,000, and the transportation and disposal will cost an additional $10,000 to $20,000 per drum. The cost to the DOE of repackaging, transportation and disposal of these 10,000 drums that contain Pu-238 is conservatively estimated to be in the range of $100 to 200 million. Moreover, these repackaged drums will consume 12% of the storage space at the WIPP facility.

One approach to avoiding repackaging is to use liquid nitrogen to make the drum contents brittle and then apply vibrations to the drum with which to shatter the bags in order to reduce the layers of confinement. There are problems associated with this technology, such as drum integrity being compromised. Moreover, the effectiveness of liquid nitrogen treatment has not been well established.

### SUMMARY OF THE INVENTION

In view of the aforementioned considerations, a non-intrusive method of releasing fluid from a material confined within a resinous enclosure, surrounded by a metal container, comprises irradiating the resinous enclosure with at least one beam of high energy radiation to rupture the resinous enclosure to allow the fluid to escape from the resinous enclosure into the metal container. In further aspects of the invention, the fluid in the metal container after the resinous container has ruptured is removable from the metal container.

In still another aspect of the invention, the fluid is vented from the metal container after the resinous enclosure is ruptured.

In still a further aspect of the invention, the high energy radiation is gamma ray radiation.

In a specific application of the invention, the invention relates to a non-intrusive method of releasing hydrogen or volatile organic compounds from nuclear waste material confined within at least one large bag of polymer material enclosed in a steel drum. The invention comprises irradiating the drum with at least one beam of gamma radiation originating outside of the drum to embrittle the polymer material and cause the bag to rupture, releasing the hydrogen or volatile organic compounds from within the bag into the drum. The hydrogen gas or volatile organic compounds are then vented from the drum.

In accordance with still another embodiment of the invention, the gamma ray source is cobalt 60, and in still a further aspect of the invention, the gamma radiation a focused beam from at least one electron accelerator.

In still a further aspect of the invention, the waste material is material containing plutonium 238 awaiting shipment and storage wherein the plutonium 238 is packaged in at least one polymer bag contained within a steel drum.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a side perspective view of a metal drum having resinous liner therein for containing a material within the resinous liner;

FIG. 2 is a view similar to FIG. 1 showing the metal drum of FIG. 1 being impinged with a beam of high energy radiation;

FIG. 3 is a view similar to FIGS. 1 and 2 but showing the resinous liner ruptured to release fluid from the material contained therein into the metal drum.

FIG. 4 is a side view of the metal drum of FIG. 1 showing the drum being irradiated by a plurality of radiation sources, and FIG. 5 is a perspective view showing a plurality of drums being advanced through an irradiation station.

### DETAILED DESCRIPTION

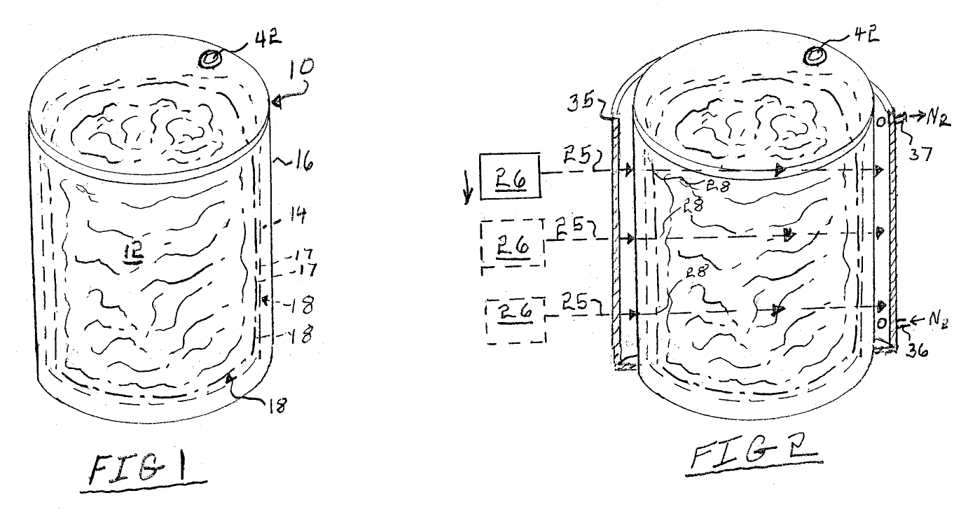

Referring now to FIG. 1 there is shown package 10 containing waste material 12 within a liner 14 of resinous material that is surrounded by steel container in the form of a drum 16. While a drum 16 is shown, the metal container surrounding the liner 14 may be of any suitable configuration. The liner 14 is typically made of layers 17 of a polymer such as polyethylene or polyvinyl chloride (PVC). Layers 17 in the same drum 16 may include both polyethylene and polyvinylchloride. While two layers 17 are shown, there may be at least several layers. In a preferred embodiment the layers 17 of liners 14 are provided by liner bags 18 which are 5 to 12 mils thick. The drums 16 are 30 gallon or 55 gallon steel drums. A batch of these drums 16 may include both sizes. In accordance with one embodiment of the invention, the material 12 transuranic waste which has radiolytic decomposition that generates hydrogen and for other explosive gases. Each layer 17 of confinement provided by liner bags 10 within the package 10 reduces gas permeability and leakage. Therefore, the risk of explosive concentrations of gas exist. If the transuranic waste 12 contains plutonium 238 a great deal of hydrogen gas is generated.

In order to avoid having to divide transuranic contents 12 of one package 10 into numerous additional packages, it is necessary to vent the package 10 comprised of the liner bag or liner bags 18 containing the transuranic waste 12. In order to avoid repackaging the transuranic waste 12 in order to meet Department of Transportation regulations which limit the amount of gas generation that may be in a single drum 16 during transportation, the liner bags 18 must be breached in order to vent explosive gases such as hydrogen and volatile organic compounds. With respect to plutonium 238, it may not be transported unless repackaged into as many as 10 additional drums if the initial drum 16 contains as little as 10 grams of plutonium 238.

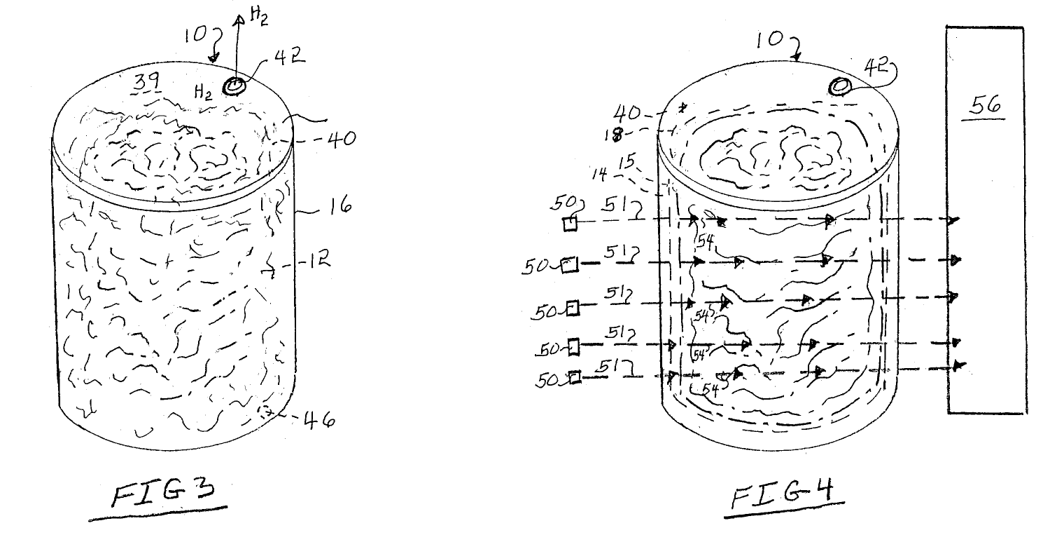

Referring now to FIG. 2, there is shown a first embodiment of the invention wherein the package 10, comprising the steel drum 16 and liner bags 18 packaging transuranic waste 12, is irradiated by a focused beam 25 of high energy gamma radiation which is emitted from an electron accelerator 26. The focused beam 25 of high energy gamma radiation accelerates cross-linking and embrittlement of the layers 15 of the liner bags 18 which retain the transuranic waste 12.

A preferable method of applying the gamma radiation beam 25 to the package 10 is to move the package horizontally through the beam or to move the beam horizontally with respect to the package, and then index or otherwise move the electron accelerator 26 in an axial direction as shown in dotted lines with respect to package 10, so as to slice through the liner bags 18 at several locations 28 inside of the steel drum 16. Since the electronic beam 25 generates substantial heat upon impinging and passing through the package 10, the drum 16 is cooled by a jacket 35 (about half of which is shown) which has an inlet 36 at the bottom thereof and an outlet 37 at the top thereof. A preferable coolant is liquid nitrogen which achieves a steady state temperature of the drum 16 of about 120° C. so as to prevent ignition of hydrogen or other volatile gases within the transuranic material 12. Instead of a jacket 35, a cooling coil around the drum 16 may be utilized comprised of, for example, ½″ copper tube.

Typically, the energy of the gamma radiation beam 25 is between 6 million electron volts and 18 million electron volts with the time of exposure ranging from 20 seconds to several minutes per slice through the package 10. An example of such an electron accelerator is the Varian Linatron 3,000A, which directs a high energy beam of electrons onto a tungsten target that produces X-rays via Bremsstrahlung interactions. The electron accelerator operator elects among gamma peak energy levels of 6, 9 and 11 million electron volts (mEv) when irradiating the package 10.

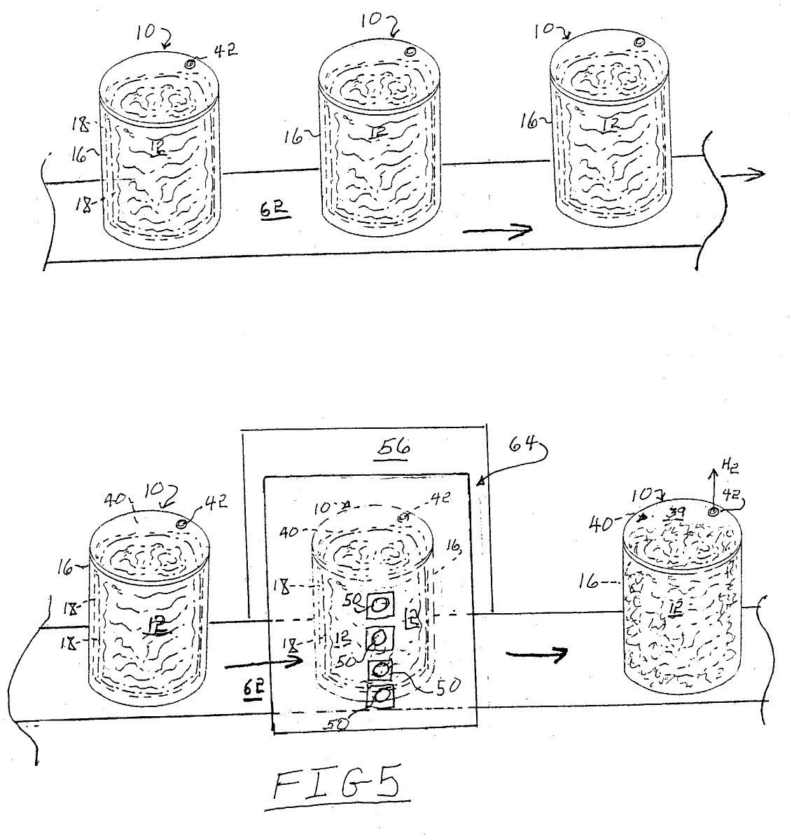

Referring now to FIG. 3, it is seen that the polymer layers 17 have ruptured allowing gas 39 to escape from the liner bags 18 and to accumulate in the head space 40 of the drum above the transuranic material 12. The gas 39 then vents through a vent 42 having a filter which allows the gas to vent, but retains particulate matter. If the transuranic waste material 12 includes plutonium 238, then the venting gas 39 is primarily hydrogen, allowing the package 10 comprising a 30 or 55 gallon drum containing the transuranic waste 12 to be transported under Department of Transportation regulations.

For other applications the invention, the waste 12 may be another kind of waste, such as industrial waste, that might contain a liquid in which case, the drum 16 is drained by a drain 46 positioned near the bottom of the drum with gases venting through the vent 42. However, the preferred use of this method is to vent gas.

Referring now to FIG. 4 there is shown a second embodiment of a method for practicing the present invention, wherein a plurality of cobalt 60 sources are arranged in a vertical array to irradiate the package 10 comprised of the steel drum 16, and the layers 15 provided by multiple liner bags 18 with gamma ray beams 51 in order to accelerate cross-linking and embrittlement of the layers 15 at a plurality of locations 54. The gamma ray beams 51 pass completely through the package 10 and are absorbed by shielding 56, which may be for example a wall made of lead.

Referring now to FIG. 5, in a preferred arrangement a conveyer, such as a conveyer belt 62, is provided to advance plurality of packages 10 through one or more irradiation stations 64 having gamma ray sources 50, such as cobalt 60, therein. The conveyer 62 may move at a steady rate or may index the packages 10 through the irradiation station 64 wherein the packages 10 are slowed down in the irradiating station or stopped in the station. By moving the packages 10 horizontally through the gamma ray beams 51, the liner bags 18 are sliced at a plurality of locations 54 which destroys the integrity of the liner bags releasing gases 39, such as hydrogen and vapors, such as volatile organic compounds, into the head space 40 of the drums for venting through vents 42 into the atmosphere.

With the embodiment of FIGS. 4 and 5 using sources 50 such as cobalt 60 it is not necessary to provide cooling of the packages 10 while they are irradiated, as is the case with the electron accelerator 25 of FIG. 2. Accordingly, the irradiation arrangement of FIGS. 4 and 5 is preferred because it is less complex, less expensive and faster.

From the foregoing description, one skilled in the art can easily ascertain the essential characteristics of this invention, and without departing form the spirit and scope thereof, can make various changes and modifications of the invention to adapt it to various usages and conditions.

We claim:

1. A non-intrusive method of releasing fluid from material confined within a resinous enclosure surrounded by a metal container, comprising:
irradiating the resinous enclosure with at least one beam of high energy radiation to rupture the resinous enclosure and to allow the fluid to escape from the resinous enclosure into the metal container.

2. A method according to claim 1 wherein the fluid in the metal container is removable from the container.

3. A method according to claim 2 wherein the fluid is gas and is removed from the metal container by venting.

4. A method according to claim 2 wherein the fluid is liquid and is removed from the metal container by draining.

5. A method according to claim 1 wherein the high energy radiation is gamma ray radiation.

6. A method according to claim 1 wherein the material is nuclear waste and the fluid is an explosive gas

7. A method according to claim 6 wherein the explosive gas is hydrogen gas or volatile organic compounds.

8. A method according to claim 7 further including testing the gas after it has accumulated in the metal container.

9. A non-intrusive method of releasing explosive gas from waste material confined within a resinous enclosure surrounded by a metal container, comprising:
irradiating the resinous enclosure with at least one beam of high energy radiation to rupture the resinous enclosure and to allow the fluid to escape from the resinous enclosure into the metal container.

10. A method according to claim 9 further including venting the explosive gas from the metal container.

11. A non-intrusive method of releasing hydrogen or volatile organic compounds from nuclear waste material confined within at least one bag of polymer material enclosed in a steel drum comprising:
irradiating the drum with at least one beam of gamma radiation originating outside of the drum to embrittle the polymer material and cause the bag to rupture thereby releasing the hydrogen or volatile organic compounds from within the bag into the drum; and
venting the drum to pass the hydrogen or volatile organic compounds out of the drum.

12. A method according to claim 11 wherein the gamma ray source is cobalt 60.

13. A method according to claim 12 wherein there are a plurality of gamma ray sources arranged in an array at an irradiation station, and wherein the drum is irradiated by being placed in proximity with the array.

14. A method in accordance with claim 13 wherein the drum is advanced through the irradiation station on a conveyer which has a plurality of other drums thereon.

15. A method in accordance with claim 12 wherein the nuclear waste material is plutonium 238 and the gas is hydrogen gas.

16. A non-intrusive method of preparing steel drums containing plutonium 238 for shipment and storage, wherein the plutonium-238 is packaged in each drum within at least one polymer bag comprising:
irradiating the drums and the at least one polymer bag therein with radiation of an intensity sufficient to rupture the at least one bag to release hydrogen from within the bag into the drum, and
venting the hydrogen from the drum.

17. A method according to claim 16 wherein the at least one bag is made of polyethylene or polyvinyl chloride.

18. A method according to claim 17 wherein the drums are 30 gallon or 55 gallon steel drums.

19. A method according to claim 18 wherein irradiating the drums is performed by exposing the drums to gamma radiation emitted from at least one source of cobalt 60.

20. A method according to claim 19 wherein there are multiple sources of cobalt 60.

21. A method according to claim 20 wherein the multiple sources are positioned at a station and wherein there is relative motion between the drums and station.

22. A method according to claim 16 wherein irradiating the drums is performed by exposing the drums to gamma radiation emitted from at least one source of cobalt 60.

23. A method according to claim 20 wherein there are multiple sources of cobalt 60.

24. A method according to claim 23 wherein the multiple sources are positioned at a station and wherein there is relative motion between the drums and station.

25. A method according to claim 16 wherein there are multiple bags arranged in layers within the drum for packaging the plutonium 238.

26. A method according to claim 17 wherein there are multiple bags arranged in layers within the drum for packaging the plutonium 238.
